(19) United States
(12) Patent Application Publication
(10) Pub. No.: US 2004/0007587 A1
(43) Pub. Date: Jan. 15, 2004

(54) Membrane piercing closure

(76) Inventor: Scott K. Westphal, Miami, FL (US)

Correspondence Address: PILLSBURY WINTHROP, LLP, P.O. BOX 10500, MCLEAN, VA, 22102, US

(21) Appl. No.: 10/190,614

(22) Filed: Jul. 9, 2002

(51) Int. Cl. B67D 5/00

(52) U.S. Cl. 222/83.5; 222/556

(57) ABSTRACT

A membrane-penetrating closure device for a container on which a sealing membrane (e.g., a metal foil) is installed. The device comprises a membrane-penetrating structure disposed within a tubular channel. One end of the tubular channel is secured to the container, while the other end is provided with a re-sealable cap. The membrane-penetrating structure is initially disposed proximate to the sealing membrane, and the closure device is arranged such that the membrane-penetrating structure will pierce the sealing membrane, thus opening the container, either as a result of opening the re-sealable cap or upon application of manual pressure to the piercing structure. The tubular channel may be provided with tamper-resistant or tamper-evident portions at one or both ends.

### BACKGROUND OF THE INVENTION

1. Field of the Invention

The invention relates generally to the field of packaging, and more specifically to devices for piercing and opening sealed packages.

2. Description of Related Art

Many types of commercial packages are sealed with thin membranes. For example, in the food industry, many food packages are heat sealed with a thin membrane that comprises a layer of metal foil coated on at least one side by a layer of a heat-sealable material, such as low density polyethylene (LDPE). The layer of metal foil in the membrane acts as a gas barrier and prevents oxygen or other contaminants from entering the package. The layer of heat-sealable material allows the membrane to be joined to the package by conventional heat-sealing techniques.

In one conventional arrangement, the type of thin membrane described above is sealed over the neck of a plastic food container, and a re-sealable cap is then threaded or otherwise connected to the container above the thin membrane. The re-sealable cap provides the user with a way to releasably close the container once the membrane has been removed. Similar types of packaging are also found in the pharmaceutical industry, where thin membranes are used to seal bottles containing medicament solutions. A variation of the typical arrangement is found in aseptic paperboard packaging. In the case of aseptic paperboard packaging (such as TETRA BRIK ASEPTIC® packaging), a thin membrane and re-sealable cap structure may be provided as a portion of a wall of the container itself.

In order to open a container with a thin sealing membrane, the user must either puncture or remove the membrane. Either opening process can be difficult. If the user tries to manually remove the membrane, it may be difficult to grip. Alternatively, if a user chooses to puncture the membrane, a separate sharp implement is usually required, and even after puncturing the membrane, the punctured pieces of the membrane may need to be manually removed. Moreover, the forces involved in puncturing or removing the membrane may jostle the contents of the container, which can cause a mess when the container opens.

Solutions have been proposed to this problem. For example, U.S. Pat. No. 5,297,696 discloses a pour spout with a piercing insert therein. The pour spout of this reference is designed to be connected as an integral part of a paper-walled container. The piercing insert within the spout is driven downwardly to penetrate the membrane by application of manual downward pressure thereto. In the initial position, the piercing insert is fixedly connected to the pour spout, however, in the process of driving the piercing insert downward, its connection to the piercing spout is broken, such that the piercing insert may later be dislodged from its resting position and fall into the container.

Other references, such as U.S. Pat. No. 6,223,924, disclose devices whereby a rotational movement of an internally threaded, specially designed cap is translated by means of cam surfaces into a downward movement of a piercing structure. Such devices are relatively complex and may be difficult or expensive to fabricate.

### SUMMARY OF THE INVENTION

One aspect of the invention provides a membrane-penetrating closure for a container having an opening sealed by a membrane. A neck structure of the closure has a first end adapted to be attached to the container above the membrane and a second end adapted to be releasably sealed. The neck structure contains a penetrating structure. The penetrating structure comprises a penetrating portion adapted to penetrate a membrane such that penetrated membrane portions remain connected to unpenetrated portions of the membrane. The penetrating portion has an aperture in at least one portion thereof. The aperture establishes a flow pathway from the penetrating portion through the penetrating structure. One or more flexible support members are connected at respective first portions thereof to exterior surfaces of the penetrating structure and at respective second portions thereof to interior surfaces of the neck structure. The flexible support members are adapted to deformably change orientation as the penetrating structure is moved into a penetrating position. The penetrating structure is moved into a penetrating position to penetrate the membrane by application of manual pressure on a pressure application surface thereof.

A further aspect of the invention provides another type of membrane-penetrating closure for a container having an opening sealed by a membrane. A tubular structure of the closure has a first end adapted to be coupled to the opening of the container above the membrane and a second end adapted to be releasably sealed. A membrane-penetrating structure is disposed within and moveably connected to the tubular structure proximate to the membrane. A re-sealable cap is releasably coupled to the tubular structure proximate to the second end thereof.

In this further embodiment, the membrane-penetrating structure is coupled to the cap such that an opening movement of the cap causes the membrane-penetrating structure to penetrate the membrane. A strap having a first end coupled to the re-sealable cap and a second end coupled to the membrane-piercing structure may be provided such that an opening motion of the cap causes the membrane-penetrating structure to penetrate the membrane. In particular, the strap may be trained over a projection of the tubular structure such that an opening movement of the cap causes a downward movement of the membrane-penetrating structure.

Alternatively, a resilient, stored energy member such as a spring may be disposed within the tubular structure such that a first end thereof is connected to the tubular structure and a second end thereof is disposed in driving relation with the membrane-penetrating structure. A restraining trigger is also provided in this variation. The restraining trigger has a first end coupled to the resilient member to prevent driven movement of the spring and a second end coupled to the cap such that an opening movement of the cap moves or deforms the restraining trigger to allow driven movement of the membrane-penetrating structure.

These and other aspects, features, and advantages of the invention will be described below.

### BRIEF DESCRIPTION OF THE DRAWINGS

The invention will be described with respect to the following drawings, in which like numerals represent like features throughout the several views, and in which:

FIG. 1 is a sectional perspective view of a portion of a membrane-sealed container having a membrane-penetrating closure according to an embodiment of the invention;

FIG. 2 is a top plan view of the penetrating structure in the closure of FIG. 1;

FIG. 3 is an elevational view of one side of the membrane-penetrating closure of FIG. 1;

FIG. 4 is an elevational view of the other side of the membrane-penetrating closure of FIG. 1;

FIG. 5A is a sectional view of the membrane-penetrating closure of FIG. 1 installed in the container in an initial position;

FIG. 5B is a sectional view of the membrane-penetrating closure of FIG. 1 in a piercing position;

FIG. 6A is a partially sectional elevational view of a membrane-penetrating device according to another embodiment of the invention, shown as installed in a container in an initial position;

FIG. 6B is a partially sectional elevational view of the membrane-penetrating device of FIG. 6A in a piercing position;

FIG. 7A is a partially sectional elevational view of a membrane-penetrating device according to a further embodiment of the invention in an initial position;

FIG. 7B is a partially sectional elevational view of the membrane-penetrating device of FIG. 7A in a piercing position;

FIG. 8 is a cross-sectional view of a pyramidal piercing blade suitable for use in membrane-penetrating devices according to embodiments of the invention; and

FIG. 9 is a cross-sectional view of a curved piercing blade suitable for use in membrane-penetrating devices according to embodiments of the invention.

### DETAILED DESCRIPTION

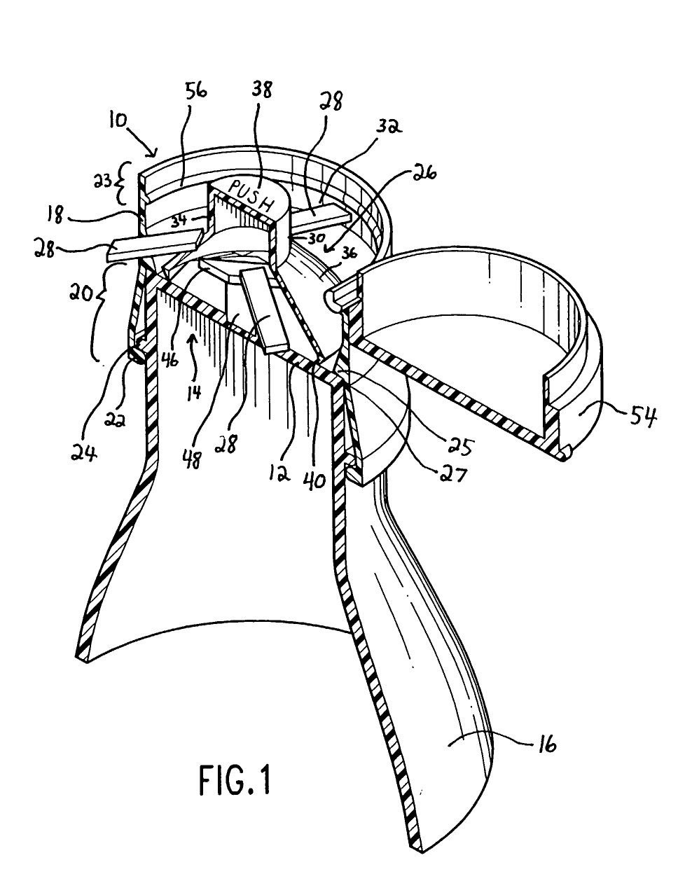

One embodiment of a membrane-penetrating closure, generally indicated at 10, is shown in the perspective view of FIG. 1. The membrane-penetrating closure 10 is installed above a membrane 12 that seals the opening 14 of a container 16. The membrane 12 may be a metal foil, such as aluminum foil, or a metal foil laminate, e.g., having layers of plastic heat-sealing material disposed on either or both sides of a layer of metal foil. In one embodiment, the container 16 is formed of a plastic material such as low or high density polyethylene (LDPE or HDPE), polyethylene terephthalate (PET), or polypropylene (PP), and is adapted for food storage. In other embodiments, the container 16 may be made of glass, metals, or other materials, and may be adapted to contain other goods, for example, pharmaceutical compositions.

The container 16 may contain a fluid, semisolid substances, such as powders, or solids, such as tablets or capsules. If the container 16 contains semisolid or solid substances, the terms “flow pathway” and “flow path,” as used herein, may be interpreted to mean a pathway of sufficient size to allow the semisolid or solid contents of the container 16 to move out of the container 16.

The membrane-penetrating closure 10 comprises a generally tubular neck structure 18. A first end 20 of the neck structure 18 is adapted to be attached to the container 16 above the membrane 12. As shown in FIG. 1, a lip 22 on the first end engages a flange 24 provided on the container 16, while an abutting lip 25 of the neck structure 18 rests on the edge 27 of the container 16. However, it is contemplated that the neck structure 18 could be formed integrally with the container 16, or the neck structure 18 could be snapped or threadedly engaged with the container 16.

The container 16 may be re-sealably closed by a cap 54 which is hingedly connected to the second end 23 of the neck structure 18 and fits sealingly over the second end 23 end. The cap 54 illustrated in FIG. 1 engages a flange 56 at the second end 23 of the neck structure 18 to seal the second end 23. However, the neck structure 18 may be provided with external threads, such that an internally threaded cap 54 may be screwed onto the second end 23 of the neck structure 18 to seal it.

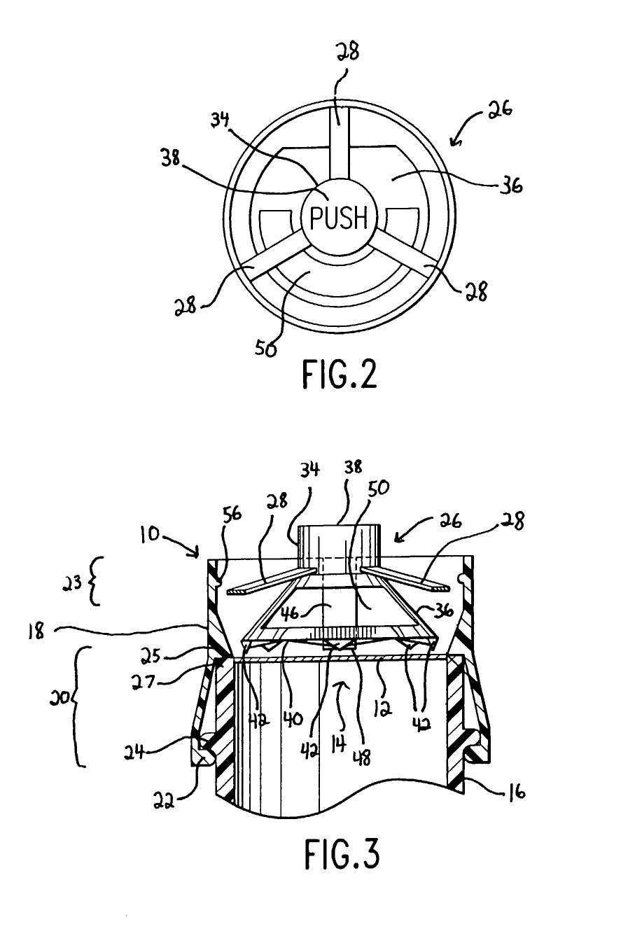

The neck structure 18 contains a penetrating structure, generally indicated at 26, that is connected thereto. The penetrating structure 26 is suspended within the neck structure 18 by three preferably flexible support members 28 that extend between the exterior surface 30 of the penetrating structure 26 and the interior surface 32 of the neck structure 18. (In FIG. 1, one of the three flexible support members 28 is shown as connected to the neck structure 18; the other two support members 28 would be connected to portions of the neck structure 18 that are cut away in the view of FIG. 1.) The flexible support members 28 are in substantially the same horizontal plane and are distributed approximately equidistantly from one another around the periphery of the penetrating structure 26. The position of the three flexible support members 28 relative to one another is better seen in FIG. 2, a top plan view of the penetrating structure 26 in isolation. Although only three flexible support members 28 are shown in FIGS. 1 and 2, any number of flexible support members 28 may be used. One or more of the support members 28 may be frangible so as to break away from the penetrating structure 26 and/or the neck structure 18, although preferably, at least one of the support members 28 remains attached to the Alternatively, a thin annulus of flexible material connected between the exterior surface 30 of the penetrating structure 26 and the interior surface 32 of the neck structure 18 may serve the function of the flexible support members 28.

The penetrating structure 26 itself is a one-piece molded component having a substantially cylindrical upper body portion 34 and a flared lower body portion 36. The penetrating structure 26 is generally hollow throughout, as shown in the sectional perspective view of FIG. 1. A pressure application surface 38 is provided at the top of the upper body portion 34. The pressure application surface 38 is of sufficient size to allow a user to apply manual downward pressure to the penetrating structure 26 with at least one finger or thumb. As shown in FIGS. 1 and 2, the pressure application surface 38 may be embossed with an appropriate directive, such as “PUSH.” Although the pressure application surface 38 is illustrated as solid in FIGS. 1 and 2, the pressure application surface 38 may include apertures therein. Additionally, any user-accessible surface of the penetrating structure 26 may serve as a pressure application surface.

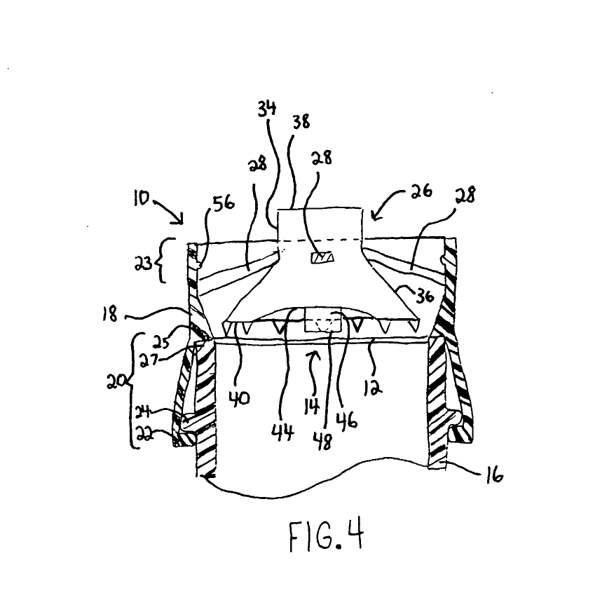

FIGS. 3 and 4 are front and back elevational views, respectively, of the penetrating structure 26. (In FIGS. 3 and 4, the container 16 and neck structure 18 are shown in section and the cap 54 is not shown.) The flared lower body portion 36 of the penetrating structure 26 extends outwardly from the upper body portion 34 and terminates in a penetrating portion 40. The penetrating portion 40 of this embodiment is an annular penetrating edge. The penetrating edge 40 has serrations 42 arrayed along at least a portion of its circumference. A portion of the penetrating edge 40 (best seen in FIG. 4) does not have serrations; this portion is a folding edge 44. The non-serrated folding edge 44 allows the penetrated portion of the membrane 12 to remain connected to the unpenetrated portions of the membrane 12, such that the penetrated flaps of membrane 12 material do not fall into the container 16. The folding edge 44 may be contoured to increase its folding effect during a downward, membrane-penetrating motion of the penetrating structure 26. In this embodiment, the folding edge 44 forms a vertically arcuate cut-out that extends upward from the penetrating edge 40.

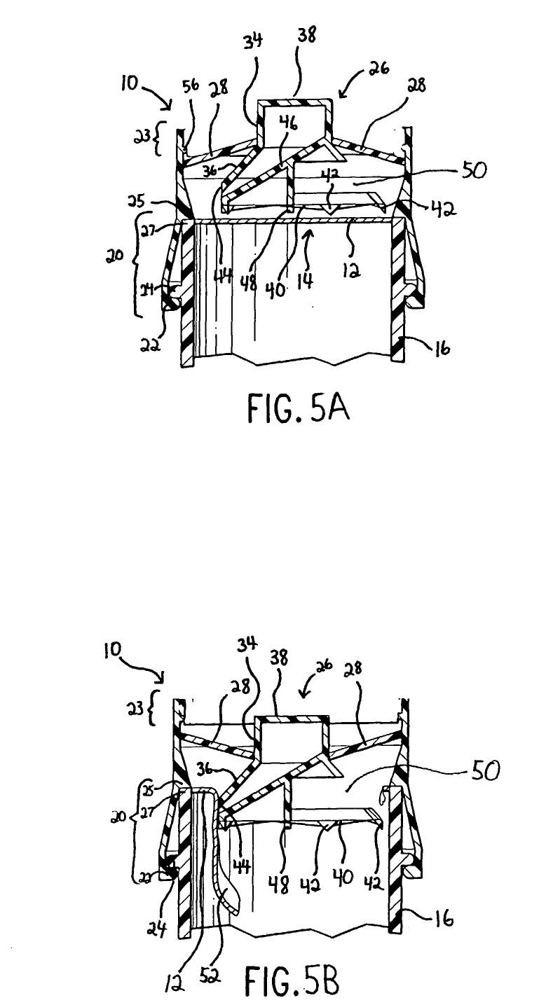

In addition to the folding edge 44, the penetrating structure 26 may include a folding arm 46 connected to interior surfaces of the penetrating structure 26 and extending downwardly therefrom. The folding arm 46 has at least one projection 48 (best seen in the sectional views of FIGS. 5A and 5B) extending to the level of the folding edge 44, and if provided, would cooperate with the folding edge 44 to fold the penetrated membrane 12 flap.

The flared lower body portion 36 also includes an aperture 50 which establishes a flow pathway through the penetrating structure 26 so that the contents of the container 16 may flow out of the container 16 once the membrane 12 is penetrated without being obstructed by the penetrating structure 26. In this embodiment, the aperture 50, which is a cut-out in the wall of the lower body portion 26, is sized so as to provide as much flow as possible through the penetrating structure 26 without compromising the strength of the penetrating structure 26 or the penetrating edge 40. The aperture 50 may be smaller or larger than that depicted, or a plurality of apertures 50 may be provided. Additionally, one of ordinary skill in the art may provide an aperture 50 having dimensions that provide for a particular flow rate. If the container 16 contains tablets or other solid contents, the aperture 50 may be sized in relation to the contents to dispense a certain number of tablets at a time (e.g., one or two tablets at a time).

The operation of the membrane piercing closure 10 and penetrating structure 26 are illustrated in the sectional views of FIGS. 5A and 5B. For simplicity, the cap 54 is not illustrated in FIGS. 5A and 5B, however, if the cap 54 were pivotably connected to the neck structure 18, it would be in an open position in FIGS. 5A and 5B. In FIG. 5A, the penetrating structure 26 is suspended just above the intact membrane 12. The three flexible support members 28 are connected at one end to the interior surface 32 of the neck structure 18 and extend slightly upwardly to the exterior surface 30 of the penetrating structure 26. (As shown, the three flexible support members 28 connect to the exterior surface 30 at the base of the upper body portion 34.) The vertical position of the penetrating structure 26 in the neck structure 18 is such that on application of manual force, the penetrating structure 26, mounted on the flexible support members 28, has enough range of travel to penetrate the membrane 12. (The range of travel of the penetrating structure 26 would typically be on the order of a few millimeters.)

To penetrate the membrane 12, the user would apply manual force to the pressure application surface 38, causing the penetrating structure 26 to move downward, from the position illustrated in FIG. 5A towards the position illustrated in FIG. 5B. During the movement from the position of FIG. 5A to the position of FIG. 5B, the flexible support members 28 remain connected between the penetrating structure 26 and the neck structure 18, but they invert in orientation during the movement. In FIG. 5B, the flexible members 28 extend downwardly from the interior surface 32 of the neck structure 18 to the exterior surface 30 of the penetrating structure 26. A membrane flap 52 is formed once the penetrating structure 26 penetrates the membrane 12. This membrane flap 52 stays connected to the membrane 12, but is folded out of the way by the action of the folding edge 44 and, if provided, the folding arm 46. The amount of manual force required to drive the penetrating structure 26 from the position illustrated in FIG. 5A to the position illustrated in FIG. 5B would depend on the number of flexible support members 28, the dimensions of the flexible support members 28, and their elastic modulus, and could be selected arbitrarily.

Once the membrane 12 has been penetrated, the penetrating structure 26 remains connected to the neck structure 18, and thus, will not fall into the container 16. Moreover, the flexible support members 26 allow the penetrating structure 26 to move from a protruded position (FIG. 5A) to a recessed position (FIG. 5B), in which the support members 28 assume an inverted position.

Membrane-penetrating closures according to embodiments of the invention may be formed of any plastic material, although moldable thermoplastic materials may be preferred for some applications. It is advantageous if the membrane-penetrating closure is molded of the same plastic material as the container, and it may also be desirable to use a recyclable plastic material. Examples of suitable recyclable plastic materials include low or high density polyethylene (LDPE or HDPE), polyethylene terephthalate (PET), and polypropylene (PP). Alternatively, if a membrane-penetrating closure is used on a container holding a liquid that would react with plastics, the membrane-penetrating closure 10 may be formed of a non-corroding metal, such as stainless steel or aluminum.

The embodiment of the membrane-penetrating closure 10 illustrated in FIGS. 1-5B is designed to operate by application of manual force, as explained above. However, in other embodiments, a penetrating structure 26 may be coupled to the cap 54 to automatically penetrate the membrane 12 on opening of the cap 54.

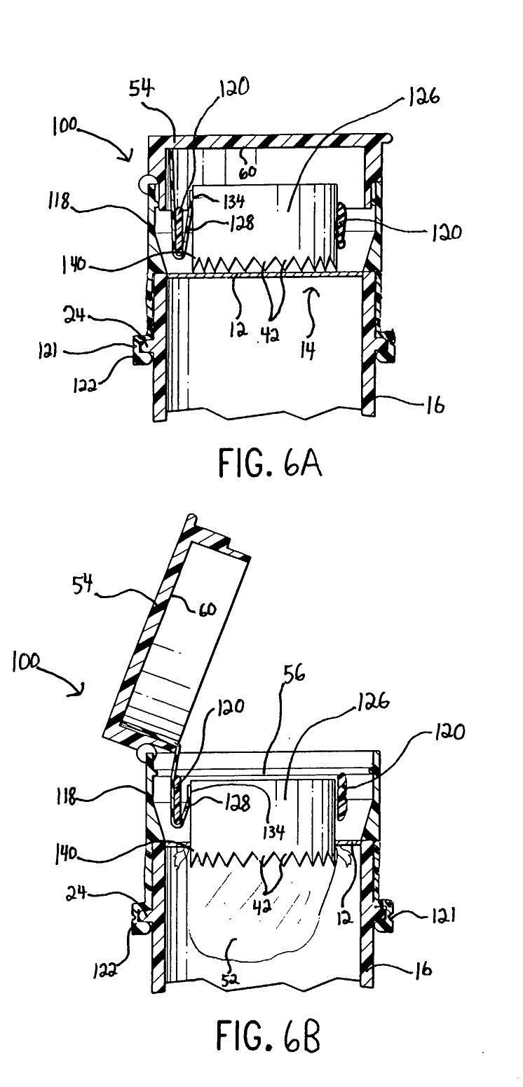

FIGS. 6A and 6B are partially sectional elevational views of a membrane-penetrating closure 100 according to another embodiment of the present invention in initial and piercing positions, respectively. (In FIGS. 6A and 6B, the container 16 is shown in section.) The penetrating structure 126 of this embodiment is tubular, with both ends open. The open, tubular nature of the penetrating structure 126 allows fluid, solid or semisolid contents to flow or move through the penetrating structure 126 without obstruction. If the penetrating structure 126 was not tubular, apertures could be provided therein to allow flow. A penetrating portion 140 is provided at one end having serrations 42 around at least part of its circumference. A non-serrated folding edge similar to the folding edge 44 of FIG. 4 (not shown in FIGS. 6A and 6B) is provided on one side of the penetrating portion 140. The penetrating structure 126 may have any diameter that will fit within the neck structure 118, and may be just smaller than the diameter of the neck structure 118 itself.

As shown in FIGS. 6A and 6B, the penetrating structure 126 is positioned within and is guided by a channel 120 that is disposed within the neck structure 118. In this embodiment, the channel 120 is a central ring of material that is connected to the neck structure 118. In other embodiments, the walls of the neck structure 118 may perform the function of the channel 120.

A cap 54 is hingedly connected to the neck structure 118 by a hinge 58 for movement between closed and open positions. (The closed position of the cap 54 is shown in FIG. 6A, while the open position of the cap 54 is shown in FIG. 6B.) As in the previous embodiment, the cap 54 engages a flange 56 on the neck structure 118 when closed. The penetrating structure 126 is coupled to the cap 54 for automatic penetration of the membrane 12 by a strap 128. The strap 128 is connected on one end to the underside surface 60 of the cap 54 and on the other end to an upper portion 134 of the penetrating structure 126. Between the underside surface 60 of the cap 54 and the penetrating structure 126, the strap 128 is trained over a portion of the channel 120 such that it extends downwardly from the underside 60 of the cap 54 to the channel 120, and then upwardly from the underside of the channel 120 to the upper portion 134 of the penetrating structure 126. In this way, the strap 128 translates an opening motion of the cap 54 into a downward, membrane-penetrating movement of the penetrating structure 126. FIG. 6B illustrates the opening movement of the cap 54 and the resultant downward movement of the penetrating structure 126 that is caused by the strap 128.

Initially, the strap 128 is connected between the cap 54 and penetrating structure 126 such that there is essentially no “slack” therein. Therefore, the penetrating structure 126 will immediately penetrate the membrane 12 when the cap 54 is opened the first time. After the membrane 12 has been penetrated, the penetrating structure 126 may slide up and down within the channel 120 during subsequent openings and closings of the cap 54, but will remain within the channel 120 and connected to the strap 128. Thus, the penetrating structure 126 will not fall into the container 16 after opening. The strap 128 may be connected to the cap 54 and penetrating structure 126 by adhesives, or by fasteners such as staples. Alternatively, if the strap 128, penetrating structure 126 and cap 54 are all made of thermoplastic materials, the strap 128 may be fused to the penetrating structure 126 and cap 54, or the strap 128 may include hooked ends that cooperate with the cap 54 and/or penetrating structure 126.

FIGS. 6A and 6B also illustrate an alternative way in which a membrane-penetrating closure according to the invention may engage a container 16. In other embodiments, a lip 22 on the closure engages a flange 24 on the container 16. In this embodiment, a channel 122 on the membrane-penetrating closure 100 engages the flange 24. The channel 122 may be more difficult to disengage from the flange 24 than a lip 22, and thus, may be more tamper-resistant. Additionally, the channel 122 is notched or otherwise weakened (e.g., by notches 121 in FIGS. 6A and 6B) at a location proximate to the flange 24 such that any attempt to remove the membrane-penetrating closure 100 from the container 16 would likely result in damage to the membrane-penetrating closure 100, such that tampering would be evident. Although shown with respect to membrane-penetrating closure 100, this tamper-resistant and tamper-evident connection may be used with any membrane-penetrating closure according to the invention. Additionally, the lip 22 may include weakened portions or notches 121.

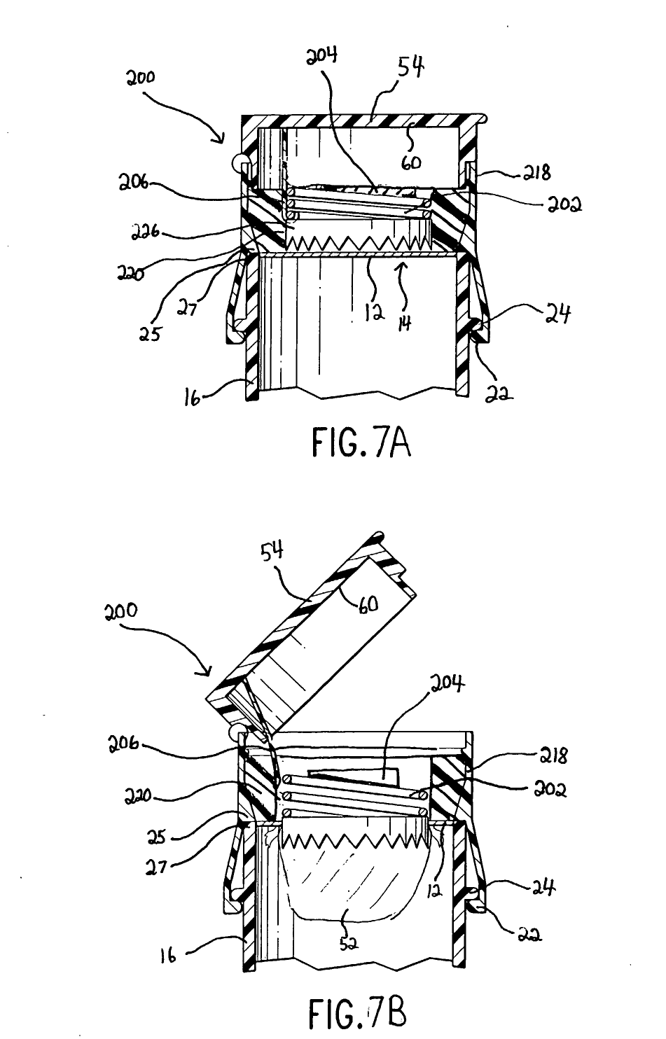

FIGS. 7A and 7B are elevational views of a membrane-penetrating closure 200 according to yet another embodiment of the invention of the present invention in initial and piercing positions, respectively. In the embodiment illustrated in FIGS. 7A and 7B, a spring 202 is used to drive the penetrating structure 226 to penetrate the membrane 12.

The penetrating structure 226 of this embodiment is substantially similar to the penetrating structure 126 that was described above. However, the penetrating structure 226 may be shorter than the penetrating structure 126. The penetrating structure 226 is slidably positioned within and is guided by a channel 220. The channel 220 of FIGS. 7A and 7B comprises a thickened section of the interior walls of the neck structure 218, although a channel 120 similar to that described above may be used with this embodiment.

The spring 202 is in driving relation with the penetrating structure 226. At one end, the spring is connected to a projection 204 in the neck structure 218 and at the other end, the spring 202 is coupled to, and may be fixedly connected to, the penetrating structure 226. A restraining trigger 206 is connected at one end to the underside 60 of the cap 54 and at the other end, is hooked about the bottom coil of the spring 202. (Alternatively, the restraining trigger 206 may be hooked about a lip at the end of the spring 202.) The restraining trigger 206 thus prevents the spring 202 from driving the penetrating structure 226 while the cap 54 is in the closed position illustrated in FIG. 7A.

The restraining trigger 206 is constructed of a plastic material of sufficient rigidity to act against the force bias provided by the spring 202. However, when the cap 54 is opened, as shown in FIG. 7B, the additional force on the restraining trigger 206 would cause the restraining trigger 206 to deform and disengage from the spring 202, allowing the spring 202 to drive the penetrating structure 226 to penetrate the membrane. Alternatively, depending on the particular dimensions of the restraining trigger 206, the movement of the cap 54 may move the restraining trigger 206 away from the spring 202 enough to allow the spring 202 to drive the penetrating structure 226.

Those of ordinary skill in the art will realize that a channel similar to channel 220 may be used with the embodiment illustrated in FIGS. 6A and 6B if an “L” shaped passageway is provided in the wall of the channel for passage of the strap 128. In addition, although a conventional spring 202 is shown in FIGS. 7A and 7B, any resilient member capable of storing mechanical energy may be used in its place. If a conventional spring is used, the spring may be made of metals or plastics.

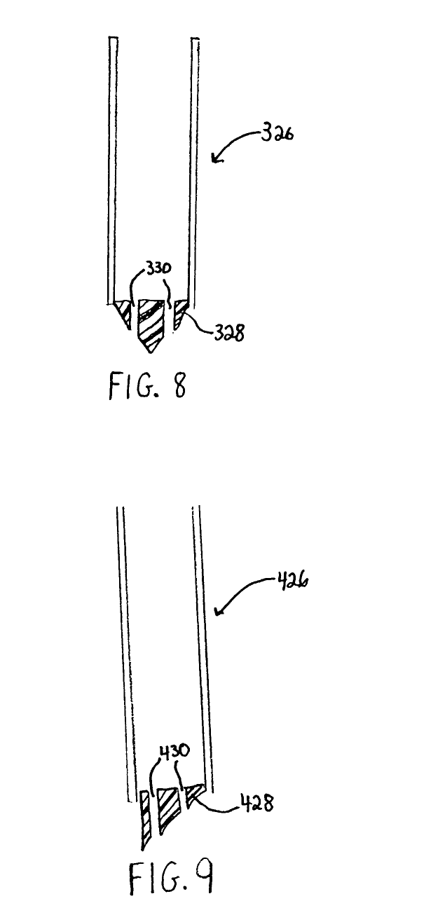

Moreover, although hollow, generally tubular penetrating structures 26, 126, 226 have been shown with respect to the various embodiments, penetrating structures of various configurations may be used. FIGS. 8 and 9 are cross-sectional views illustrating two appropriate types of penetrating structures 326, 426. Penetrating structure 326 of FIG. 8 is generally tubular but has a pyramidal blade 328 disposed on its cutting end. The pyramidal blade 328 is provided with channels 330 therein that provide a passage through the blade 328. Penetrating structure 426 of FIG. 9 is also generally tubular but has a curved blade 428 disposed on its cutting end. The curved blade 428 is provided with channels 430 therein that provide a passage through the blade 428. In addition, conical blades similar to pyramidal blade 328 may be used.

In addition to the tamper-evident connection described above, a membrane-penetrating closure 10, 100, 200 according to embodiments of the invention provides certain other tamper-evident features and advantages. For example, if the membrane 12 has been penetrated or the contents of the container 16 have leaked while the closure 10, 100, 200 is still in the initial position, the user would be alerted that the container 16 may have been tampered with. Moreover, the membrane-penetrating closure 10, 100, 200 and the container 16 may be configured to produce a noise when the membrane 12 is penetrated. For example, if the container 16 is evacuated before being sealed with the membrane 12, the penetration of the membrane 12 may produce an audible popping noise as the pressure inside the container 16 equalizes with the atmospheric pressure. The membrane-penetrating closure 10, 100, 200 may also be configured to produce a popping or snapping noise as it moves from its initial position into a penetrating position. For example, using the membrane-penetrating closure 10, a snapping or popping noise may be generated if one of the support members 28 is frangible and breaks during the movement of the membrane-penetrating closure 10.

Although the invention has been described with respect to several exemplary embodiments, those of ordinary skill will realize that variations and modifications are possible within the scope of the invention. The embodiments described herein are intended to be exemplary only and are not to be construed as limiting.

What is claimed is:

1. A membrane-penetrating closure for a container having an opening sealed by a membrane, comprising:
a neck structure having a first end adapted to be attached to the container above the membrane and a second end adapted to be releasably sealed, the neck structure containing therein a penetrating structure, the penetrating structure comprising
a penetrating portion adapted to penetrate a membrane, the penetrating portion being configured such that penetrated membrane portions remain connected to unpenetrated portions of the membrane, the penetrating structure having an aperture in at least one portion thereof, the aperture establishing a flow path from the penetrating portion through the penetrating structure; and
one or more flexible support members connected at respective first portions thereof to exterior surfaces of the penetrating structure and at respective second portions thereof to interior surfaces of the neck structure, the flexible support members being adapted to deformably change orientation as the penetrating structure is moved into a penetrating position.

2. The membrane-penetrating closure of claim 1, wherein the penetrating structure is substantially tubular, and wherein the penetrating portion is an annular edge on a lower portion of the penetrating structure, the annular edge having a serrated region and a folding region, the folding region being contoured to fold the penetrated membrane portions away from an opening formed in the membrane by the penetrating portion.

3. The membrane-penetrating closure of claim 2, wherein the aperture is provided in a lateral wall portion of the penetrating structure.

4. The membrane-penetrating closure of claim 1, wherein the one or more flexible support members comprise a plurality of flexible support bars connected substantially equidistantly from one another between the penetrating structure and the neck structure.

5. The membrane-penetrating closure of claim 1, the penetrating structure further comprising a pressure application surface on a user-accessible portion thereof.

6. The membrane-penetrating closure of claim 5, wherein the pressure application surface is a substantially horizontal surface provided at a top portion thereof.

7. The membrane-penetrating closure of claim 1, wherein the neck structure is substantially tubular.

8. The membrane-penetrating closure of claim 7, further comprising a cap, the cap being adapted to releasably seal the second end of the neck structure.

9. The membrane-penetrating closure of claim 7, the neck structure further comprising a lip disposed at the first end thereof and extending around substantially the entirety of its circumference, the lip being adapted to engage a corresponding flange provided on a surface of the container.

10. The membrane-penetrating closure of claim 9, wherein tamper-evident portions of the neck structure adjacent the lip have a decreased failure strength.

11. The membrane-penetrating closure of claim 9, wherein tamper-evident portions of the neck structure adjacent the lip include weakening notches formed therein.

12. The membrane-penetrating closure of claim 1, wherein the membrane-penetrating closure is formed of a plastic material.

13. The membrane-penetrating closure of claim 12, wherein the plastic material is selected from the group consisting of polyethylene terephthalate, high-density polyethylene, low-density polyethylene, and polypropylene.

14. A container comprising a vessel having an opening, a membrane sealing the opening, and a membrane-penetrating closure according to claim 1.

15. A membrane-penetrating closure device for a container, the container having an opening sealed by a membrane, comprising:
a tubular structure having first and second ends, a first end of the tubular structure adapted to be coupled to the opening of the container above the membrane and a second end thereof adapted to be releasably sealed;
a membrane-penetrating structure disposed within and moveably connected to the tubular structure proximate to the membrane;
a re-sealable cap releasably coupled to the tubular structure proximate to the second end thereof; and
a strap having a first end coupled to the re-sealable cap and a second end coupled to the membrane-penetrating structure such that an opening movement of the re-sealable cap causes the membrane-penetrating structure to penetrate the membrane.

16. The closure device of claim 15, wherein the first end of the strap is connected to the membrane-penetrating structure, the second end of the strap is connected to the re-sealable cap, and a portion of the strap between the first and second ends is trained over a projection of the tubular structure such that an opening motion of the re-sealable cap causes a downward motion of the membrane-penetrating structure.

17. The closure device of claim 15, wherein the membrane-penetrating structure includes apertures positioned and adapted to form a flow pathway therethrough.

18. The closure device of claim 15, wherein the membrane-penetrating structure comprises a tubular body adapted to fit slidingly within the tubular structure, an end of the tubular body disposed proximate to the membrane having a serrated region and a folding region.

19. The closure device of claim 15, wherein an end of the membrane-penetrating structure disposed proximate to the membrane comprises a contoured blade.

20. The closure device of claim 15, wherein an end of the membrane-penetrating structure disposed proximate to the membrane comprises a pyramidal blade.

21. The closure device of claim 15, wherein an end of the membrane-penetrating structure disposed proximate to the membrane comprises a conical blade.

22. The closure device of claim 15, further comprising a lip provided on the first end of the tubular structure, the lip being adapted to connect the tubular structure with the opening of the container.

23. The closure device of claim 22, wherein the lip is adapted to engage a complimentary flange provided proximate to the opening of the container.

24. The closure device of claim 23, wherein the lip further comprises deformable tamper-evident portions.

25. The closure device of claim 23, wherein the lip further comprises frangible tamper-evident portions.

26. The closure device of claim 15, wherein the closure device is formed of a plastic material.

27. The closure device of claim 26, wherein the plastic material is selected from the group consisting of polyethylene terephthalate, high-density polyethylene, low-density polyethylene, and polypropylene.

28. A container comprising a vessel having an opening, a membrane sealing the opening, and a closure device according to claim 15.

29. A membrane-penetrating closure device for a container, the container having an opening sealed by a membrane, comprising:
a tubular structure having first and second ends, a first end of the tubular structure adapted to be coupled to the opening of the container above the membrane and a second end thereof adapted to be releasably sealed;
a membrane-penetrating structure disposed within and moveably connected to the tubular structure proximate to the membrane;
a re-sealable cap releasably coupled to the tubular structure proximate to the second end thereof;
a resilient stored-energy member disposed within the tubular structure, the resilient member having first and second ends, the first end of the resilient member being connected to the tubular structure and the second end of the resilient member being disposed in driving relation with the membrane-penetrating structure; and
a restraining trigger having first and second ends, the first end of the restraining trigger being coupled to the resilient member to prevent driven movement of the membrane-penetrating structure, and the second end of the restraining trigger being coupled to the re-sealable cap such that an opening motion of the re-sealable cap moves or deforms the restraining trigger to allow driven movement of the membrane-penetrating structure.

30. The membrane-penetrating closure of claim 29, wherein the resilient stored-energy member is a spring.

31. The closure device of claim 29, wherein the membrane-penetrating structure includes apertures positioned and adapted to form a flow pathway therethrough.

32. The closure device of claim 29, wherein the membrane-penetrating structure comprises a tubular body adapted to fit slidingly within the tubular structure, an end of the tubular body disposed proximate to the membrane having a serrated region.

33. The closure device of claim 32, wherein an end of the membrane-penetrating structure disposed proximate to the membrane comprises a contoured blade.

34. The closure device of claim 32, wherein an end of the membrane-penetrating structure disposed proximate to the membrane comprises a pyramidal blade.

35. The closure device of claim 32, wherein an end of the membrane-penetrating structure disposed proximate to the membrane comprises a conical blade.

36. The closure device of claim 29, further comprising a lip provided on the first end of the tubular structure, the lip adapted to form a connection with the opening of the container.

37. The closure device of claim 36, wherein the lip is adapted to engage a complimentary flange provided proximate to the opening of the container.

38. The closure device of claim 37, wherein the lip further comprises deformable tamper-evident portions.

39. The closure device of claim 37, wherein the lip further comprises frangible tamper-evident portions.

40. The closure device of claim 29, wherein the closure device is formed of a plastic material.

41. The closure device of claim 40, wherein the plastic material is selected from the group consisting of polyethylene terephthalate, high-density polyethylene, low-density polyethylene, and polypropylene.

42. A container comprising a vessel having an opening, a membrane sealing the opening, and a closure device according to claim 29.
